(19) United States
(12) Patent Application Publication
(10) Pub. No.: US 2015/0339777 A1
(43) Pub. Date: Nov. 26, 2015

(54) SYSTEMS, METHODS, AND APPARATUS FOR STACKING INSURANCE DEDUCTIBLES

(71) Applicant: The Travelers Indemnity Company, Hartford, CT (US)

(72) Inventor: Daniel Zhalov, West Hartford, CT (US)

(73) Assignee: The Travelers Indemnity Company, Hartford, CT (US)

(21) Appl. No.: 14/285,990

(22) Filed: May 23, 2014

(51) Int. Cl. G06Q 40/08

(52) U.S. Cl. CPC G06Q 40/08

(57) ABSTRACT

Systems, apparatus, methods, and articles of manufacture provide for facilitating management of insurance claims, including determining a stacked deductible amount based on a deductible associated with coverage of an insured's property and a deductible associated with liability coverage against damage to third parties.

### BACKGROUND

A deductible for an insurance policy is applicable to claim settlement and establishes risk sharing between an insurer and an insured. A deductible typically is offered in exchange for a reduced policy premium. Accordingly, failure to recover a deductible may lead to a decrease in profitability. Typically, during the settlement of a first party claim by an insured (for example, based on a comprehensive and/or collision automobile coverage policy), the insurer determines an estimated cost to repair the insured's vehicle. When the payment for the repair is dispersed to the insured, the insurer may reduce the payment amount by the amount of any deductible previously established for the relevant coverage.

Attempts at offering deductibles to insureds for third party liability coverage for damages to third parties (e.g., bodily injury and/or property damage to others as a result of an insured's automobile accident) have been met with some difficulties. Typically, in the case of a liability claim brought by a third party, any amount due to the third party is provided to the third party relatively quickly. If a deductible is associated with the liability coverage policy, the insurer must collect the liability deductible from the insured (typically, after the payment to the third party has been made). The insured may have little incentive to pay back to the insurer the deductible amount he or she owes and/or to pay it back in a timely manner. Accordingly, in order to recover the deductible amount established by the terms of the liability coverage policy, the insurer may have to resort to collection efforts, leading to additional processing costs and increased customer dissatisfaction. Despite the importance to the insurance industry of offering competitive policy coverage options, reducing costs, and preventing negative customer experiences (e.g., resulting from collection efforts), previous systems and practices have failed to optimize deductible options for third party liability insurance policies.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1A is a diagram of a system according to some embodiments of the present invention;

FIG. 1B is a diagram of a claim management system according to some embodiments of the present invention;

FIG. 2 is a diagram of a computer system according to some embodiments of the present invention;

FIG. 3 is a flowchart of a method according to some embodiments of the present invention; and

FIG. 4A and FIG. 4B are a flowchart of a method according to some embodiments of the present invention.

### DETAILED DESCRIPTION

Applicants have recognized that, in accordance with some embodiments described in this disclosure, insurance providers, insurance claim professionals, and others may find it beneficial to utilize a process for management of an insurance claim that allows for efficient application of a deductible associated with liability coverage for damages to third parties (e.g., bodily and/or property damage).

Applicants further have recognized that some types of entities may find it beneficial to utilize a process for managing insurance claims in which a deductible amount associated with liability coverage (e.g., for damages to third parties) is applied against a payout amount due to an insured in accordance with coverage for damage to a first party (e.g., comprehensive and/or collision coverage for damage to an insured's property; personal injury coverage for the insured). In some embodiments, a deductible amount associated with liability coverage may be combined with or added to (also referred to as “stacking” in this disclosure) a deductible for comprehensive and/or collision coverage. In one example, in the context of an automobile accident having both associated liability for damages to a third party and associated physical damage to an insured's automobile, a total deductible amount may be determined by adding an amount of a liability deductible (corresponding to the liability coverage) to an amount of a collision deductible (corresponding to collision coverage).

Applicants further have recognized that, in accordance with one or more embodiments, some types of entities may find it beneficial: (i) to provide a payout to an insured for damage to the insured's property, in which the payout amount is reduced by a liability deductible associated with liability coverage (and may be further reduced by any collision deductible or other deductible associated with coverage for the insured's property) and/or (ii) to provide no payout to an insured for damage to the insured's property, in the case that a combination of any liability deductible and any collision deductible associated with an accident is greater than or equal to an amount due to the insured for damage to the insured's property.

Applicants further have recognized that, in accordance with one or more embodiments, some types of entities may find it beneficial: (i) to identify one or more customers (e.g., from a set of current and/or potential insureds) who may benefit from having the option of liability deductible, (ii) to establish at least one option, and respective pricing for each option, for a deductible for liability coverage, (iii) to offer at least one option for a deductible for liability coverage to a customer, and/or (iv) to record an indication that an insurance policy is associated with a deductible for liability coverage.

In accordance with some embodiments of the present invention, one or more systems, apparatus, methods, articles of manufacture, and/or computer readable media (e.g., a non-transitory computer readable memory storing instructions for directing a processor) are provided for one or more of: (i) to determine a liability deductible associated with a liability coverage insurance policy, (ii) to determine a first party deductible (e.g., a collision deductible) associated with an insured's property coverage insurance policy (e.g., collision and/or comprehensive automobile insurance), (iii) to determine a liability payout amount due to a third party in accordance with the liability coverage insurance policy, (iv) to determine a first payout amount due to an insured in accordance with the insured's property coverage insurance policy (e.g., based on an estimated cost to repair the insured's automobile and/or other property), (v) to determine a second payout amount to provide to the insured based on the liability deductible, the first party deductible, and the first payout amount, and (vi) to provide to the insured the second payout amount.

Some embodiments described in this disclosure provide for the aggregation, analysis, and preparation of data (e.g., historical claim data, property data, injury claim data, damage claim data, and/or vehicle data) for use in providing one or more of the beneficial functions described in this disclosure.

Applicants have recognized that it may be desirable, in accordance with some embodiments, to provide one or more user interfaces for offering a liability deductible to a customer (e.g., an insured or potential insured), storing an indication of acceptance of a liability deductible, and/or determining a payout amount to provide to an insured in association with an insurance claim. In one embodiment, a user interface (e.g., provided via an application, such as a web browser, running on or presented via a computing device) allows for receiving information (e.g., from a claim professional, claimant, or other user, and/or from a server computer) for determining a payout amount. Alternatively or in addition, the payout amount may be received from another computing device (e.g., a remote server, a web server) and/or may be presented to a user via an interface (e.g., by displaying or otherwise communicating the determined payout amount to the user).

It should be understood that the embodiments described in this disclosure are not limited to use with a desktop computer (although some embodiments may be described with reference to such devices, for ease of understanding), but are equally applicable to any computing device, such as a mobile device, or a personal or client computer (e.g., in a user's home or office). Any embodiments described with reference to a desktop computer or user device in this disclosure should be understood to be equally applicable to any such other types of computing device, as deemed appropriate for any particular implementation(s).

Throughout the description that follows and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

As used in this disclosure, the term “third party” may be used to refer to persons and/or entities that (i) are not the insured corresponding to a liability coverage insurance policy and (ii) who may be the recipient of payouts in accordance with an insured's liability coverage (e.g., as a result of an automobile accident involving the insured). As used in this disclosure, the insured in the situation described just above may be referred to as a “first party” for the purposes of discussing and distinguishing different types of insurance coverage and/or deductibles that may be relevant to a particular incident (e.g., an automobile accident). In one example, a “first party deductible” may be associated with an automobile insurance policy and/or other type of property insurance covering damage to property of the insured. Typically, a first party deductible amount (e.g., a collision deductible associated with an automobile collision coverage) would be deducted from any amount paid out to an insured under a first party property insurance policy (e.g., to repair a damaged automobile).

As used in this disclosure, “liability coverage” may refer to insurance coverage and/or an insurance policy directed to insuring against damage or harm to third parties (i.e., other than the insured taking out the insurance policy), such as bodily injury and/or damage to property of third parties. In one example, liability coverage may be established to insure an insured against damage to third parties and/or their property that are the fault of the insured (e.g., as a result of a collision or other accident involving the insured's automobile). A deductible associated with liability coverage, as discussed with respect to various embodiments in this disclosure, may be referred to as a “liability deductible.”

Although some examples discussed in this disclosure may refer, for purposes of illustration of some embodiments, to collision coverage (e.g., related to coverage for damage caused by operation of a vehicle), it will be readily understood that embodiments related to other types of personal property coverage (e.g., comprehensive coverage against property damage by causes other than vehicle operation) are contemplated.

As used in this disclosure, “appraisal”, “claim appraisal”, “damage claim appraisal”, and “damage appraisal” may be used synonymously and may refer to a process for appraising damaged property that may involve one or more of: (i) determining an estimate of loss to the value of damaged property, (ii) determining an estimate of the cost to repair or replace damaged property (e.g., to its condition prior to being damaged), and (iii) determining the current value of the damaged property (e.g., the value of a damaged automobile that was in an accident). Various ways of appraising damaged property are known to those of skill in the relevant art.

As used in this disclosure, “claim estimate”, “insurance claim estimate”, “repair estimate”, “damage estimate”, and “damage claim estimate” may be used synonymously and may refer to a determined value or cost (e.g., $3,000) to repair damaged property (e.g., to its condition prior to being damaged). A claim estimate value may be determined, for example, by a contractor, repair shop, and/or an appraisal professional (e.g., employed by an insurer).

As used in this disclosure, “computing device” may refer to, without limitation, one or more personal computers, laptop computers, set-top boxes, cable boxes, network storage devices, server computers, media servers, automatic teller machines (ATM), kiosks, personal media devices, communications devices, display devices, financial transaction systems, vehicle or dashboard computer systems, televisions, stereo systems, video gaming systems, gaming consoles, cameras, video cameras, MP3 players, mobile devices, mobile telephones, cellular telephones, GPS navigation devices, smartphones, tablet computers, portable video players, satellite media players, satellite telephones, wireless communications devices, personal digital assistants (PDA), point of sale (POS) terminals, credit card transaction systems, online or Internet purchase systems, and/or credit card or other financial account card transaction systems.

As used in this disclosure, “mobile device” and “portable device” may refer to, without limitation, a handheld computer, a wearable computer, a personal digital assistant, a cellular telephone, a network appliance, a camera, a smart phone, a network base station, a media player, a navigation device, a game console, or any combination of any two or more of such computing devices.

According to some embodiments, a client computer or other type of computing device may comprise one or more mobile devices, including but not limited to mobile telephones, cellular telephones, GPS navigation devices, smartphones such as a Blackberry™, Palm™, Windows™ phone, iPhone™ Galaxy S4™ by Samsung, HTC One™ by HTC, and tablet computers such as an iPad™ by Apple, Slate™ by HP, Ideapad™ by Lenovo, Xoom™ by Motorola, Kindle Fire™ by Amazon, or Nexus 7™ by Google, and other types of handheld, wearable and/or portable computing devices (e.g., a Google Glass™ wearable computing device by Google). Some type of users may find it beneficial to use a mobile device controlled in accordance with one or more of the embodiments described in this disclosure. In one example, a client computer may comprise a smartphone. Other types of computing devices are discussed in this disclosure, and still others suitable for various embodiments will be apparent to those of ordinary skill in light of this disclosure.

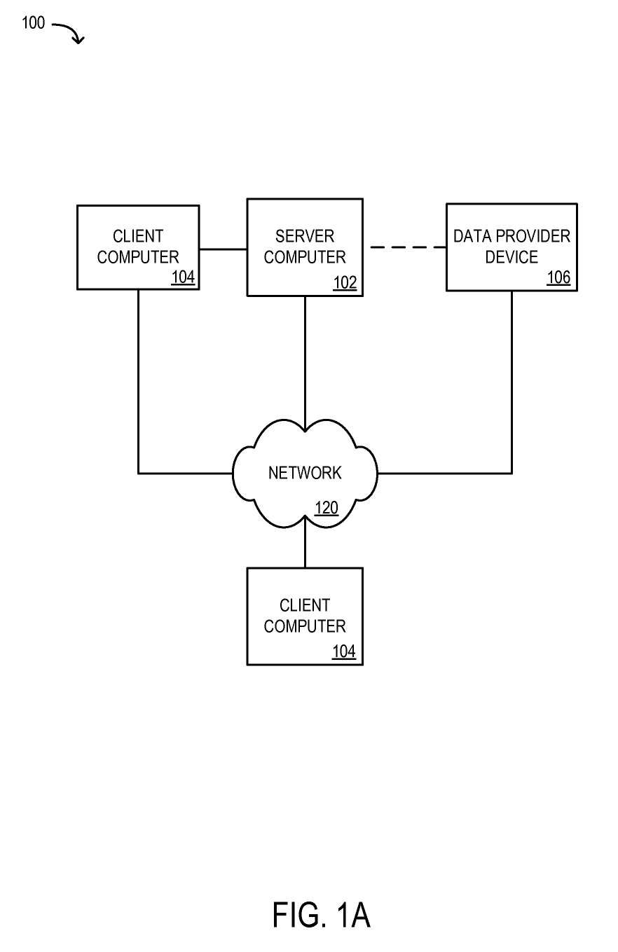

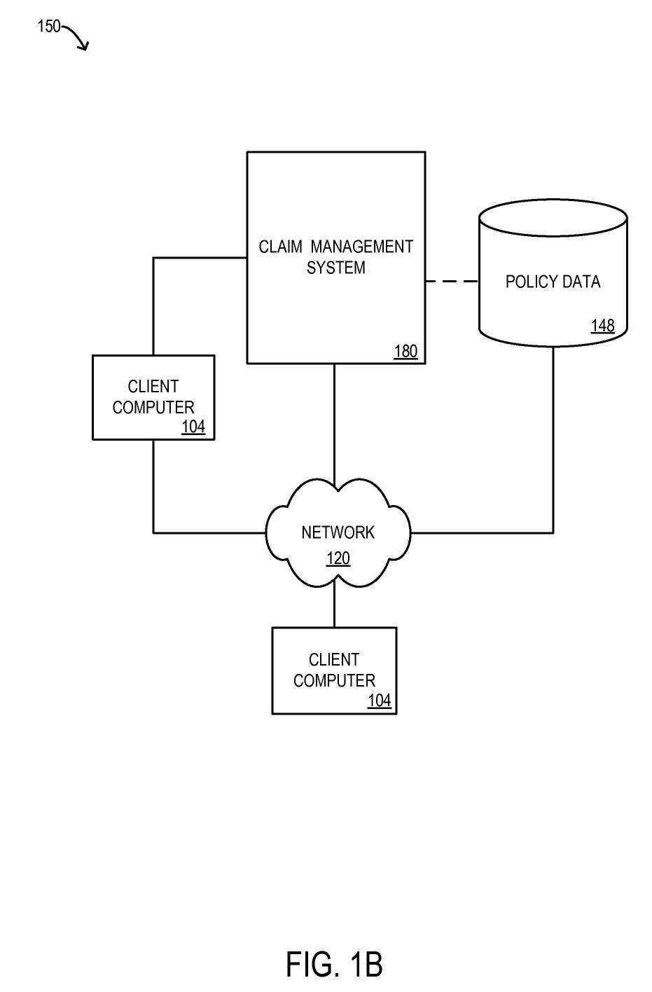

FIG. 1A depicts a block diagram of an example system 100 according to some embodiments. The system 100 may comprise one or more client computers 104 in communication with a controller or server computer 102 (e.g., a web server) via a network 120. Typically a processor (e.g., one or more microprocessors, one or more microcontrollers, one or more digital signal processors) of a client computer 104 or server computer 102 will receive instructions (e.g., from a memory or like device), execute those instructions, and perform one or more processes defined by those instructions. Instructions may be embodied, for example, in one or more computer programs and/or one or more scripts.

In some embodiments a server computer 102 and/or one or more of the client computers 104 receives (e.g., from a user), stores, and/or has access to data that is associated with one or more first party damage claims (e.g., for damage to an insured's automobile) and/or one or more liability claims (e.g., for damage to third parties) and useful for determining payment amounts to make to insureds and/or third parties based on such damage claims. Such information may include one or more of: (i) claim information (e.g., about one or more claims) and/or (ii) policy data (e.g., for insurance policies associated with one or more insureds).

According to some embodiments, any or all of such data may be stored by or provided via one or more optional data provider devices 106 of system 100. A data provider device 106 may comprise, for example, an external hard drive or flash drive connected to a server computer 102, a remote computer system (e.g., operated by or behalf of an entity other than an insurer) for storing and serving data (e.g., claim and/or policy data) for use in performing one or more functions described in this disclosure, or a combination of such remote and/or local data devices. In one embodiment, one or more companies and/or end users may subscribe to or otherwise purchase data and receive the data via the data provider device 106.

In some embodiments, the server computer 102 may comprise one or more electronic and/or computerized controller devices such as computer servers communicatively coupled to interface with the client computers 104 and/or data provider devices 106 (directly and/or indirectly). The server computer 102 may, for example, comprise PowerEdge™ M910 blade servers manufactured by Dell, Inc. of Round Rock, Tex. which may include one or more Eight-Core Intel® Xeon® 7500 Series electronic processing devices. According to some embodiments, the server computer 102 may be located remote from the client computers 104. The server computer 102 may also or alternatively comprise a plurality of electronic processing devices located at one or more various sites and/or locations.

According to some embodiments, the server computer 102 may store and/or execute specially programmed instructions to operate in accordance with one or more embodiments described in this disclosure. The server computer 102 may, for example, execute one or more programs that facilitate, via the network 120, determining a payout amount that insurer is to disburse to an insured in association with a first party damage claim and third party liability claim, based on any corresponding, respective deductibles.

In some embodiments, a client computer 104, such as a computer workstation or terminal of a claim professional of an insurance company, may comprise a desktop computer (e.g., a Dell OptiPlex™ desktop by Dell, Inc.) or a workstation computer (e.g., a Dell Precision™ workstation by Dell Inc.), and/or a mobile or portable computing device such as a smartphone (e.g., the iPhone or iPad manufactured by Apple, the Blackberry manufactured by Research in Motion, or the Moto X manufactured by Motorola), a Personal Digital Assistant (PDA), cellular telephone, laptop (e.g., a Dell Latitude™ by Dell Inc.) or other portable computing device, and an application for determining insurance policy terms and/or processing insurance claims (e.g., including determining amounts to pay out to an insured) is stored locally on the client computer 104, which may access information (e.g., coefficient data) stored on, or provided via, the server computer 102. In another embodiment, the server computer 102 may store some or all of the program instructions, and the client computer 104 may execute the application remotely via the network 120 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices (e.g., a desktop computer with a stand-alone application) without a central authority. In such an embodiment, any functions described herein as performed by a server computer and/or data described as stored on a server computer may instead be performed by or stored on one or more such devices, such as a client computer or table computer. Additional ways of distributing information and program instructions among one or more client computers 104 and/or server computers 102 will be readily understood by one skilled in the art upon contemplation of the present disclosure.

FIG. 1B depicts a block diagram of an example system 150 according to some embodiments. The system 150 may comprise one or more client computers 104 in communication with a claim management system 180 via a network 120. In one embodiment, a claim management system 180 may be hosted by, for example, a server computer 102. According to some embodiments, a payment processing system (not shown) may be integrated into a claim management system 180, for example, as a module, subsystem, or other functionality accessible through the claim management system 180.

In one embodiment, information about a particular claim may be stored by and/or accessible by claim management system 180 for managing insurance claims. For example, stored information about a claimant, the insured property associated with an insurance policy, information about third parties and/or third party claims, and/or other information from an insured's file, may be accessible by claim management system 180, without requiring manual input by a claim professional.

In one embodiment, information about one or more insurance policies may be stored in policy database 148. For example, stored information about an insured's insurance coverage(s) (e.g., collision coverage, third party liability coverage), including information about any respective deductibles associated with one or more types of insurance coverage, may be requested by and/or transmitted to the claim management system 180 (e.g., for use in determining an amount to pay out to an insured).

According to one example system, a claim management system 180 includes a web service comprising an interface enabling communication between and among distributed applications. Web services typically enable cross-platform integration by enabling applications that are written in various programming languages to communicate by using a standard web-based protocol, such as Simple Object Access Protocol (SOAP). In one example, a client, such as a web application or desktop application, may communicate using SOAP and/or HTTP with a web service (e.g., using Java® or Microsoft® .NET code) and/or the web service may communicate with one or more servers such as a Teradata® Data Warehouse Appliance™ by Teradata Corporation, a SAS Stored Process Server™ or SAS® Metadata Server™ by SAS.

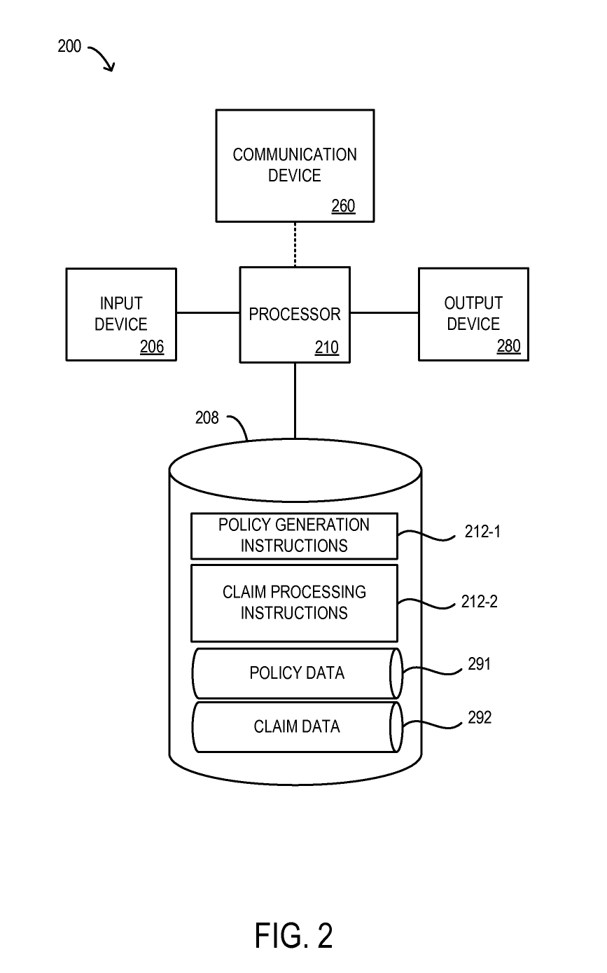

Turning to FIG. 2, a block diagram of an apparatus 200 according to some embodiments is shown. In some embodiments, the apparatus 200 may be similar in configuration and/or functionality to any of the client computers 104, server computers 102, data provider devices 106, and/or claim management system 180 of FIG. 1A and/or FIG. 1B. The apparatus 200 may, for example, execute, process, facilitate, and/or otherwise be associated with any of the processes described in this disclosure.

In some embodiments, the apparatus 200 may comprise an input device 206, a memory device 208 (e.g., a non-transitory computer readable storage device or other non-transitory computer readable medium), a processor 210, a communication device 260, and/or an output device 280. Fewer or more components and/or various configurations of the components 206, 208, 210, 260, 280 may be included in the apparatus 200 without deviating from the scope of embodiments described in this disclosure.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 900 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a physical and/or virtual keyboard that allows an operator of the apparatus 200 to interface with the apparatus 200 (e.g., such as to enter data or compose an electronic message). The input device 206 may comprise, for example, one or more of a pointer device (e.g., a mouse), a camera, and/or a headphone jack. Input device 206 may include one or more of a keypad, touch screen, or other suitable tactile input device. Input device 206 may include a microphone comprising a transducer adapted to provide audible input of a signal that may be transmitted (e.g., to the processor 210 via an appropriate communications link) and/or an accelerometer or other device configured to detect movement of the device.

The output device 280 may, according to some embodiments, comprise a display screen and/or other practicable output component and/or device. The output device 280 may, for example, provide to an insurance claim professional (e.g., via a computer workstation) an indication of a payment amount due to an insured, as determined in accordance with one or more embodiments discussed in this disclosure.

Output device 280 may include one or more speakers comprising a transducer adapted to provide audible output based on a signal received (e.g., via processor 210).

According to some embodiments, the input device 206 and/or the output device 280 may comprise and/or be embodied in a single device, such as a touch-screen display.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals to a server in communication with a plurality of handheld, mobile and/or telephone devices. According to some embodiments, the communication device 260 may also or alternatively be coupled to the processor 210.

Communication device 260 may include, for example, a receiver and a transmitter configured to communicate via signals according to one or more suitable data and/or voice communication systems. In some embodiments, the communication device 260 may comprise an IR, RF, Bluetooth™, and/or Wi-Fi® network device coupled to facilitate communications between the processor 210 and another device (such as one or more mobile devices, server computers, central controllers, and/or data provider devices). For example, communication device 260 may communicate voice and/or data over mobile telephone networks such as GSM, CDMA, CDMA2000, EDGE or UMTS. Alternately, or in addition, communication device 260 may include receiver/transmitters for data networks including, for example, any IEEE802.x network such as Wi-Fi or Bluetooth™.

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 208 may, according to some embodiments, store one or more of policy generation instructions 212-1 (e.g., computer readable software code), claim processing instructions 212-2, policy data 291, and/or claim data 292. In some embodiments, any one or more of the instructions 212-1 and/or 212-2 may be utilized by the processor 210 to provide output information via the output device 280 and/or the communication device 260 (e.g., via one or more user interfaces).

According to some embodiments, policy generation instructions 212-1 may be operable to cause the processor 210 to facilitate creating and/or modifying an insurance policy. In some embodiments, an application for insurance coverage may be entered by a user (e.g., an insurance professional employed by an insurer) via a user interface. In some embodiments, an insurance professional may utilize a user interface operating in accordance with policy generation instructions 212-1 to establish an insurance policy for liability coverage with a liability deductible. In one example, a drop-down menu may be presented via a user interface, the menu including a user-selectable option for a deductible for third party liability coverage. An insurance professional may, in response to a customer's acceptance of the liability deductible option, select the corresponding menu item. Policy generation instructions 212-1 may then, for example, store an indication of the liability deductible is association with the liability insurance coverage (e.g., in policy data database 148). Policy generation instructions 212-1 may comprise, for example, instructions for rating a policy and/or storing information about the policy for processing and/or renewal. In one embodiment, a rate is requested for an applied-for insurance policy. For example, a request for a rate is processed, based on application information and desired coverage options, via a policy rating engine and the determined rate may be stored, in association with various terms of the policy (including information about any associated deductibles), in a policy data database.

According to some embodiments, the claim processing instructions 212-2 may be operable to cause the processor 210 to process at least one claim associated with an insured's insurance coverage(s) as described in this disclosure. Various ways of receiving information about claims from insured and/or third parties are well known to those of skill in the art. In accordance with various embodiments discussed in this disclosure, claim processing instructions 212-2 may be operable to cause the processor 210 to perform one or more of: (i) determining a liability deductible associated with liability coverage associated with the claim; (ii) determining a first party deductible (e.g., a collision deductible) associated with a property coverage insurance policy (e.g., collision and/or comprehensive automobile insurance) associated with the claim; (iii) determining a liability payout amount due to a third party in accordance with the liability coverage; (iv) determining a first payout amount due to an insured in accordance with the insured's property coverage (e.g., based on a damage appraisal value); (v) determining a second payout amount (e.g., by reducing or otherwise adjusting the first payout amount) based on the liability deductible, the first party deductible, and the first payout amount; and (vi) facilitating the disbursing of the determined second payout amount to the insured.

In one example, a determined payout amount owed to an insured (e.g., after reducing a damage estimate by stacking a collision deductible with a liability deductible) may be indicated to a claim professional and/or a claimant. In one embodiment, claim processing instructions 212-2 may be configured to direct a processor to transmit a message to an insurance professional and/or to an insured, including information about the determined second payout amount.

In one example, a claim is processed in association with an automobile accident, in which the claim includes both (i) a first party damage component (e.g., covered physical damage to the insured's automobile) and (ii) a liability component (e.g., covered damage or injury to a third party).

According to some embodiments, the apparatus 200 may function as a computer terminal and/or server of an insurance provider, for example, that is utilized to process or manage insurance claims and assess payout amounts due to insureds. In some embodiments, the apparatus 200 may comprise a web server and/or other portal (e.g., an interactive voice response unit (IVRU)) that provides policy data 291 and/or claim data 292 to various types of users.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 or may simply be accessible to the apparatus 200 (e.g., externally located and/or situated).

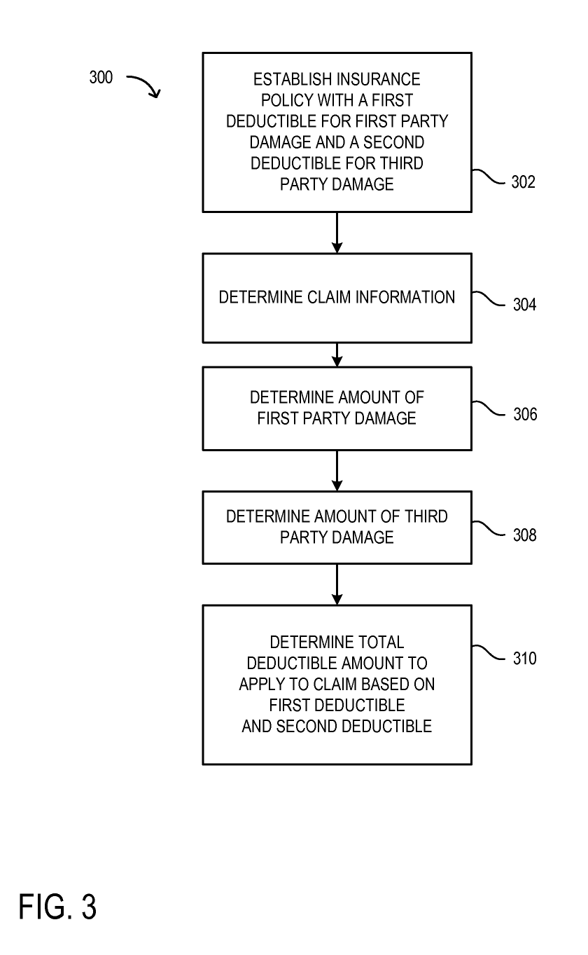

Referring now to FIG. 3, a flow diagram of a method 300 according to some embodiments is shown. The method 300 may, for example, be performed by or on behalf of an insurer, a claim professional, a claimant, and/or other type of user. It should be noted that although some of the steps of method 300 may be described herein as being performed by a server computer, while other steps are described herein as being performed by another computing device, any and all of the steps may be performed by a single computing device, which may be a client computer, server computer, data provider device or another computing device. Further, any steps described herein as being performed by a particular computing device may be performed by a human or another computing device as appropriate.

According to some embodiments, the method 300 may comprise establishing an insurance policy with a first deductible for first party damage (e.g., for damage experienced by a first party) and a second deductible for third party damage (e.g., for damage experienced by a third party), at 302. According to some embodiments, the first deductible for the insurance policy may be for applying to any type of first party damage, such as, without limitation, property damage (e.g., to an insured's home and/or car) and/or to personal injury damage to the first party. The second deductible may, for example, be for applying to any type of damage to a third party (e.g., a third party's property, a personal injury of the third party). In one embodiment, the first deductible is for first party automobile collision damage and the second deductible is for damage to third party property.

In one embodiment, establishing an insurance policy may comprise offering an insurance customer one or more deductible options for collision coverage, personal injury coverage, and/or liability coverage with respect to third parties. The customer may select one of the offered third party liability deductible options. In some embodiments, establishing an insurance policy may comprise storing information (e.g., in a policy data database) with regard to the established policy, the insured, and/or an indication of one or more deductibles associated with the insurance policy.

According to some embodiments, the method 300 may comprise determining claim information associated with a damage claim, injury claim, and/or property loss claim, at 304. In one embodiment, claim information may comprise claim, accident, claimant, third party, and/or and vehicle information relevant to a particular claim (e.g., for an automobile accident). The information may comprise, for example, one or more of: claim information about an insurance claim, personal information about a claimant, personal information about a third party, information about circumstances of an accident or other loss event, information about an injury to a third party, and/or property information about the damaged property (e.g., information about a damaged vehicle and/or third party property).

Determining the information may comprise, in accordance with some embodiments, one or more of: accessing stored electronic data; receiving the information via a user interface (e.g., from a claim professional or other user) or input device, and/or receiving a signal including an indication of the information from a client computer, mobile device, web server, server computer, claim management system, and/or data provider device. Claim information may be received (e.g., via a mobile device or other type of computing device) from a claimant (e.g., a driver involved in an accident), insurance professional, third party (e.g., a party other than the insured, injured in an accident; an accident responder), and/or a sensor device (e.g., an in-vehicle telemetric/telematic device, a GPS-enabled device, a device comprising an accelerometer). Such information may be stored, in some embodiments, on a server computer and/or a claim management system.

According to some embodiments, the method 300 may comprise determining an amount of first party damage (e.g., property and/or personal injury damage), at 306, and determining an amount of third party damage, at 308. According to some embodiments, determining the respective amounts of damage may comprise determining the damage amounts based on the determined claim information. In one embodiment, determining the amount of first party damage may comprise determining an amount of collision damage (e.g., to a first party's automobile or other vehicle).

According to some embodiments, the method 300 may comprise determining a total deductible amount to apply to the claim, based on the first deductible and the second deductible, at 310. In one embodiment, determining the total deductible amount to apply to the claim comprises adding the first deductible (e.g., a deductible for collision damage) and the second deductible (e.g., a deductible for third party property and/or personal injury damage), which may be referred to in this disclosure as “stacking” the cross-coverage deductibles. In some embodiments, determining the total (stacked) deductible amount comprises adding the first deductible to the lesser of (i) the amount actually paid to the third party for the third party damages and (ii) the deductible for third party damage. In one embodiment, determining the total deductible amount may comprise determining which of the amount actually paid to the third party and the deductible for third party damage is the lesser amount (and/or determining if they are equal). Accordingly, one or more embodiments may comprise determining the total deductible amount to apply to the claim, based on (i) the deductible for first party damage, (ii) the deductible for third party damage, and (iii) the amount of third party damage.

Some embodiments may further comprise one or more of: determining a total amount to pay out to an insured based on the total deductible amount to apply to the claim, and paying out the total amount to the insured. In one example, the total amount to pay out may comprise the determined amount of first party damage, less the total deductible amount. In another example, if the stacked, total deductible amount is greater than or equal to the amount of first party damage (e.g., collision damage), then, in accordance with some embodiments, no payout is made to the insured. In some embodiments, any deductible amount in excess of the amount of the first party damage is written off (i.e., the insured is not responsible for paying in the excess deductible amount).

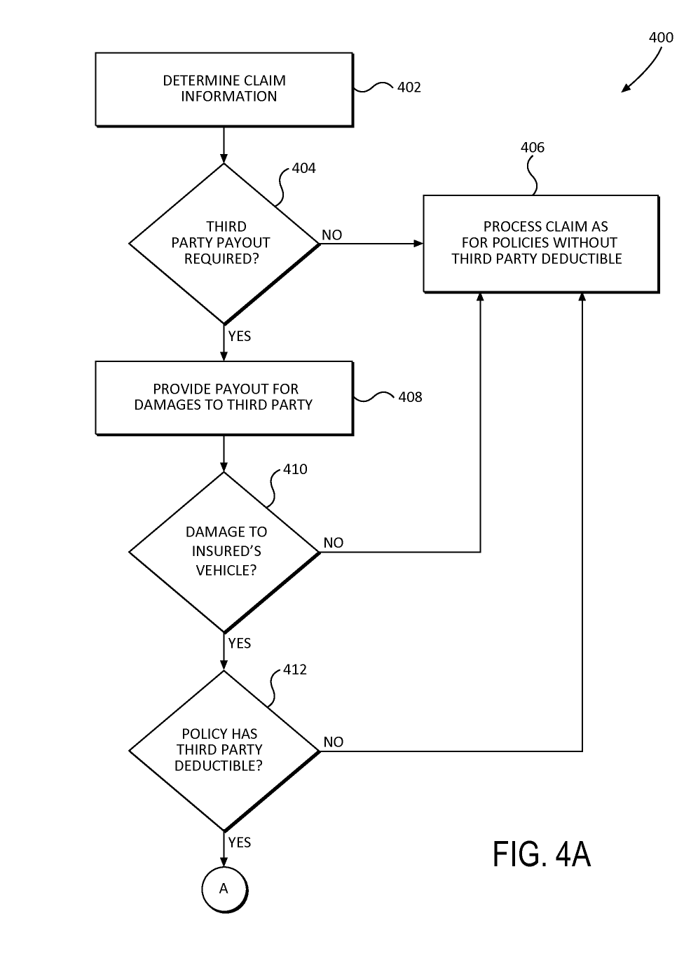

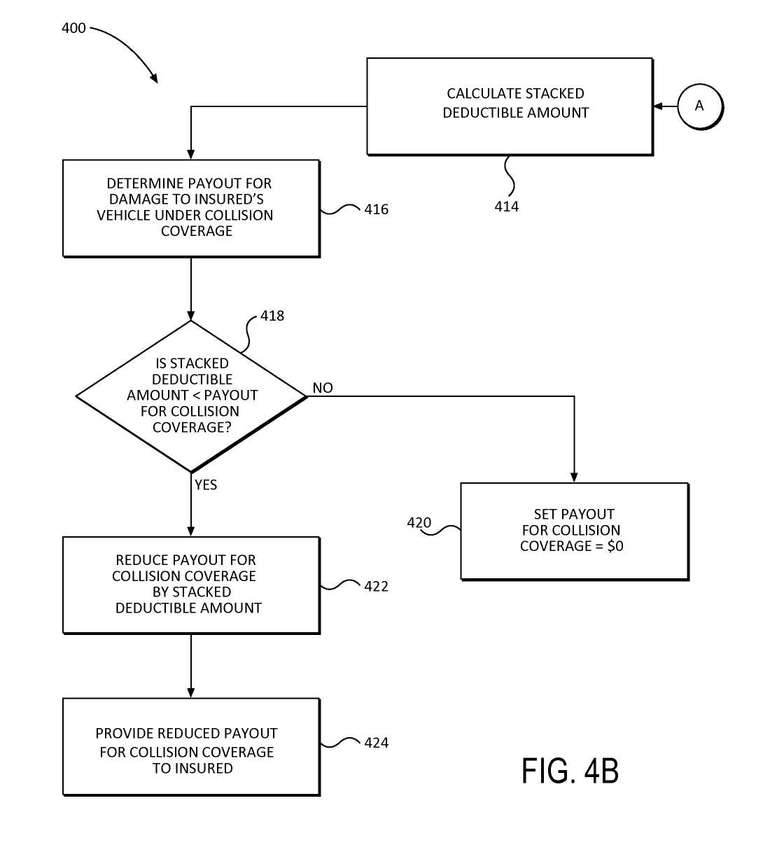

Referring now to FIG. 4A and FIG. 4B, a flow diagram of a method 400 according to some embodiments is shown. The method 400 may, for example, be performed by or on behalf of an insurer, a claim professional, a claimant, and/or other type of user. It should be noted that although some of the steps of method 400 may be described herein as being performed by a server computer while other steps are described herein as being performed by another computing device, any and all of the steps may be performed by a single computing device, which may be a client computer, server computer, data provider device or another computing device. Further, any steps described herein as being performed by a particular computing device may be performed by a human or another computing device as appropriate.

According to some embodiments, the method 400 may comprise determining claim information, at 402, and determining whether a third party payout is required, at 404. Various types of claim information, including information about one or more policies associated with a claim, are discussed in this disclosure and/or may be readily apparent to one of skill in the art. In one example, determining whether a third party payout is required may comprise determining (e.g., based on the claim information) that there was an injury to a third party and/or damage to third party property that is covered by liability coverage issued to the insured. If no third party payout is required, then the claim may be managed in accordance with an insurer's practices for processing claims without deductibles for third party liability coverage, at 406. Various ways of processing liability claims without deductibles are known to those of skill in the art.

According to some embodiments, if a third party payout is required (as determined at 404), the method 400 may further comprise providing the payout for damages to the third party, at 408. In one example, an insurer may issue a check or otherwise transfer funds to the third party to compensate for covered damages.

According to some embodiments, the method 400 may comprise determining (e.g., based on the claim information) whether there is damage to the insured's vehicle (e.g., damage to the insured's automobile as a result of an accident), at 410. If not, then the claim may be processed in accordance with the insurer's practices for processing claims without deductibles for third party liability coverage, at 406.

According to some embodiments, if there is damage to the insured's property (as determined at 410), the method 400 may further comprise determining (e.g., based on policy information associated with liability coverage) whether a policy associated with the claim has a third party deductible, at 412. In one example, policy data stored in a database may be reviewed to determine whether a third party deductible is associated with the policy. If not, then the claim may be processed in accordance with the insurer's practices for processing claims without deductibles for third party liability coverage, at 406.

According to some embodiments, if there is a third party deductible associated with the claim (as determined at 412), the method 400 may further comprise calculating a stacked deductible amount, at 414, shown in FIG. 4B. In one or more embodiments, calculating the stacked deductible amount may comprise adding a collision deductible (if any) to the lesser of (i) the third party payout and (ii) the third party deductible. In one embodiment, calculating the stacked deductible amount may comprise adding (i) the collision deductible associated with the damage to the insured's vehicle and (ii) the third party deductible. The method 400 may further comprise determining a payout for damage to the insured's vehicle under the insured's collision coverage, at 416. In one example, determining the payout may comprise determining a damage appraisal value (e.g., based on a professional appraisal of damage) to repair a damaged vehicle.

According to some embodiments, the method 400 may further comprise determining whether the stacked deductible amount is less than the determined payout for collision coverage, at 418. If not, i.e., if the stacked deductible amount is equal to or greater than the payout due to the insured to compensate for the damage to the insured's vehicle, then the payout for the collision coverage is set to $0 and/or no payout is made to the insured. If the stacked deductible amount is less than the determined payout for collision coverage, then the payout is reduced by the stacked deductible amount, at 422, and the reduced payout is provided to the insured, at 424.

The following examples provide some example policy information and example claim information related to hypothetical claim scenarios. In a first example, a personal property policy is established with a first deductible of $200 for collision coverage and a second deductible of $1,000 for coverage for liability to third parties for property damage. A claim associated with a vehicle accident is filed, and the claim information includes a liability portion of $25,000 to fix a third party's vehicle, and a collision portion of $7,000 to repair the insured's vehicle. The $25,000 is paid to the third party. Instead of applying only the $200 deductible against the collision portion and requiring the insured pay the insurer the $1,000 liability deductible, a stacked deductible amount of $1,200 is determined, in accordance with some embodiments discussed in this disclosure, by adding the collision deductible of $200 to the liability deductible of $1,000. As it is less than the collision coverage payout, the stacked deductible amount of $1,200 is subtracted from the collision coverage payout of $7,000 to generate a reduced payout amount of $5,800 payable to the insured to fix the insured's vehicle.

According to another example, using the same example deductible amounts in the example above, a claim associated with a vehicle accident is filed, and the claim information includes a liability portion of $200 to fix a third party's vehicle, and a collision portion of $7,000 to repair the insured's vehicle. The $200 is paid to the third party. In accordance with some embodiments discussed in this disclosure, a stacked deductible amount of $400 is determined by adding the collision deductible of $200 to the lesser of (i) the amount actually paid for the liability portion ($200) and (ii) the liability deductible ($1,000). The stacked deductible amount of $400 is less than the collision coverage payout amount of $7,000, so the stacked deductible amount is subtracted from the collision coverage payout of $7,000 to generate a reduced payout amount of $6,600 payable to the insured to fix the insured's vehicle.

According to another example, using the same example deductible amounts in the example above, a claim associated with a vehicle accident is filed, and the claim information includes a liability portion of $25,000 to fix a third party's vehicle, and a collision portion of $1,000 to repair the insured's vehicle. The $25,000 is paid to the third party. In accordance with some embodiments discussed in this disclosure, a stacked deductible amount of $1,200 is determined by adding the collision deductible of $200 to the liability deductible of $1,000. As the stacked deductible amount of $1,200 is not less than the determined collision coverage payout amount of $1,000, the stacked deductible amount would exceed the $1,000 cost to repair the insured's vehicle, and the claim would be closed without any payout to the insured. In one embodiment, the excess deductible amount of $200 (above the cost to fix the damage to the insured's vehicle) is waived for the insured.

One or more of the methods described in this disclosure may involve one or more user interfaces. In some embodiments, a method may include providing an interface through which a user may be allowed to enter one or more of an identifier that identifies a claim and/or any other information about a claim, person, vehicle, claimant, property, or accident associated with a claim.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “computer-readable memory device”, and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

What is claimed is:

1. An apparatus comprising:
a processor; and
a computer-readable memory in communication with the processor, the computer-readable memory storing instructions configured so that when executed by the processor the instructions direct the processor to:
determine information relating to a claim associated with damage to an insured, the information comprising an indication of an insurance policy associated with the claim;
determine a first deductible amount for damage to the insured associated with the insurance policy;
determine a second deductible amount for third party liability associated with the insurance policy;
determine an amount of damage to the insured associated with the claim;
determine an amount of damage to a third party associated with the claim;
determine a total deductible amount to apply to the claim, based on the first deductible amount and the second deductible amount; and
transmit an indication of the total deductible amount.

2. The apparatus of claim 1, the instructions being further configured to direct the processor to:
facilitate payment of the amount of damage to the third party.

3. The apparatus of claim 1, the instructions being further configured to direct the processor to:
determine an amount to pay out to the insured for the damage to the insured.

4. The apparatus of claim 3, wherein determining the amount to pay out to the insured for the damage to the insured property comprises:
determining that the total deductible amount is less than the amount of damage to the insured; and
subtracting the total deductible amount from the amount of damage to the insured to determine the amount to pay out to the insured.

5. The apparatus of claim 3, wherein determining the amount to pay out to the insured for the damage to the insured comprises:
determining that the total deductible amount is not less than the amount of damage to the insured; and
in response to determining that the total deductible amount is not less than the amount of damage to the insured, determining that no amount is to be paid out to the insured for the damage to the insured.

6. The apparatus of claim 3, the instructions being further configured to direct the processor to:
facilitate payment to the insured of the determined amount to pay out to the insured for the damage to the insured.

7. The apparatus of claim 1, wherein determining the total deductible amount to apply to the claim comprises:
adding the first deductible amount and the second deductible amount to generate the total deductible amount.

8. The apparatus of claim 1, wherein determining the total deductible amount to apply to the claim comprises:
determining the total deductible amount to apply to the claim, based on the first deductible amount, the second deductible amount, the amount of damage to the insured, and the amount of damage to the third party.

9. The apparatus of claim 1, wherein determining the total deductible amount to apply to the claim comprises:
adding the first deductible amount to the lesser of (i) the amount of damage to the third party and (ii) the second deductible amount.

10. The apparatus of claim 1, wherein the damage to the insured comprises at least one of:
damage to property of the insured and a personal injury to the insured.

11. A claim management system comprising:
a processor;
a user interface controlled by the processor;
a first computer-readable memory in communication with the processor, the first computer-readable memory storing a database of policy data; and
a second computer-readable memory in communication with the processor, the second computer-readable memory storing claim processing instructions configured so that when executed by the processor the instructions direct the processor to:
determine claim information relating to a claim;
determine, based on the claim information, that a third party payout is required for the claim;
determine, based on the claim information, that damage occurred to an insured;
accessing, from the database of policy data, policy information for a policy associated with the claim;
determine, based on the policy information, that a third party deductible is associated with the policy;
determine, based on the policy information, that a deductible for damage to the insured is associated with the policy;
calculate a stacked deductible amount by adding the deductible for damage to the insured to the lesser of (i) the third party payout and (ii) the third party deductible;
determine, based on the claim information, a damages payment for the damage to the insured;
determine whether the stacked deductible amount is less than the damages payment; and
perform one of:
(i) if the stacked deductible amount is less than the damages payment, reducing the damages payment by the stacked deductible amount, and providing the reduced damages payment to the insured, or
(ii) if the stacked deductible amount is not less than the damages payment, not providing any damages payment to the insured.

12. The claim management system of claim 11, the instructions being further configured to direct the processor to:
facilitate payment of the third party payout to a third party.

13. The claim management system of claim 11, the instructions being further configured to direct the processor to:
transmit an indication of the stacked deductible amount.

14. The claim management system of claim 11, wherein the damage to the insured comprises at least one of: damage to property of the insured and a personal injury to the insured.

15. A non-transitory computer readable medium storing instructions configured so that when executed by a processor of a computing device the instructions direct the processor to:
determine, by a computing device comprising at least one processor, information relating to a claim associated with damage to an insured, the information comprising an indication of an insurance policy associated with the claim;
determine, by the computing device, a first deductible amount for damage to the insured associated with the insurance policy;
determine, by the computing device, a second deductible amount for third party liability associated with the insurance policy;
determine, by the computing device, an amount of damage to the insured associated with the claim;
determine, by the computing device, an amount of damage to a third party associated with the claim;
determine, by the computing device, a total deductible amount to apply to the claim, based on the first deductible amount and the second deductible amount; and
transmit, by the computing device, an indication of the total deductible amount.

16. The non-transitory computer readable medium of claim 15, the instructions being further configured to direct the processor to:
facilitate payment of the amount of damage to the third party.

17. The non-transitory computer readable medium of claim 15, the instructions being further configured to direct the processor to:
determine an amount to pay out to the insured for the damage to the insured.

18. The non-transitory computer readable medium of claim 15, wherein determining the amount to pay out to the insured for the damage to the insured comprises:
determining that the total deductible amount is less than the amount of damage to the insured; and
subtracting the total deductible amount from the amount of damage to the insured to determine the amount to pay out to the insured.

19. The non-transitory computer readable medium of claim 15, wherein determining the amount to pay out to the insured for the damage to the insured comprises:
determining that the total deductible amount is not less than the amount of damage to the insured; and
in response to determining that the total deductible amount is not less than the amount of damage to the insured, determining that no amount is to be paid out to the insured for the damage to the insured.

20. The non-transitory computer readable medium of claim 15, the instructions being further configured to direct the processor to:
facilitate payment to the insured of the determined amount to pay out to the insured for the damage to the insured.

21. The non-transitory computer readable medium of claim 15, wherein determining the total deductible amount to apply to the claim comprises:
adding the first deductible amount and the second deductible amount to generate the total deductible amount.

22. The non-transitory computer readable medium of claim 15, wherein determining the total deductible amount to apply to the claim comprises:
determining the total deductible amount to apply to the claim, based on the first deductible amount, the second deductible amount, the amount of damage to the insured, and the amount of damage to the third party.

23. The non-transitory computer readable medium of claim 15, wherein determining the total deductible amount to apply to the claim comprises:
adding the first deductible amount to the lesser of (i) the amount of damage to the third party and (ii) the second deductible amount.

24. The non-transitory computer readable medium of claim 15, wherein the damage to the insured comprises at least one of: damage to property of the insured and a personal injury to the insured.
